(19) United States
(12) Patent Application Publication
(10) Pub. No.: US 2005/0050303 A1
(43) Pub. Date: Mar. 3, 2005

(54) Hierarchical reorder buffers for controlling speculative execution in a multi-cluster system

(76) Inventors: Roni Rosner, Binyamina (IL); Micha G. Moffie, Caesarea (IL)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/611,380

(22) Filed: Jun. 30, 2003

(51) Int. Cl. G06F 9/30

(52) U.S. Cl. 712/218

(57) ABSTRACT

A hierarchical distributed reorder buffer including local reorder buffers in each execution cluster and a minimal global reorder buffer. Local reorder buffers maintain program order for each execution unit which may perform out of order processing on speculatively fetched instructions. The global reorder buffer maintains program order between execution clusters and facilitates distributed recovery from mispredicted instructions.

### BACKGROUND

1. Field of the Invention

The embodiments of the invention relate to computer systems. Specifically, the embodiments of the invention relate to the maintenance of program order for the parallel execution of instructions.

2. Background

A central processing unit (CPU) of a computer system may include multiple execution clusters for processing instructions in parallel. Processing instructions in parallel increases the processing speed and efficiency of the computer system. Instructions are retrieved from a memory or storage device to be processed by an execution cluster. The instructions that are retrieved from memory may include instructions that conditionally branch to other sections of a program. The retrieval of instructions may be done in groups of sequential instructions. The retrieval of instructions may include speculative retrieval of instructions based on a ‘guess ’ of which path through a set of instructions is likely to be taken when a conditional branch instruction is executed.

The instructions that are retrieved are apportioned to each of the execution clusters. The apportionment of instructions may be based on cluster availability, cluster capabilities, a scheduling algorithm or similar considerations. The instructions may be apportioned to the execution units in sets of sequential instruction or as individual instructions.

The instructions have a sequential order in which they must be processed by the CPU for the proper function of the computer system and applications running on the computers system. Execution clusters may process the instructions out of order. However, the results of the processing of the instructions must then be reordered before they are used to update the architecture of a processor or used to generate signals to other components of a computer system. The instruction order of instructions assigned to execution clusters is tracked in a single global reorder buffer. This global reorder buffer is used by the circuitry that transfers the results of the executed instructions into the overall architecture of the CPU to determine which execution cluster contains the next instruction to be implemented in computer architecture.

### BRIEF DESCRIPTION OF THE DRAWINGS

Embodiments of the invention are illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

FIG. 1 is a diagram of a computer system.

FIG. 2 is a diagram of a processor and memory.

FIG. 3A is a diagram of an initial state of the distributed reorder buffer.

FIG. 3B is a diagram of a detection of a mispredict in a distributed reorder buffer.

FIG. 3C is a diagram of the issuance of a flush command in the distributed reorder buffer.

FIG. 3D is a diagram-of a flush operation in the distributed reorder buffer.

FIG. 3E is a diagram of the state of the distributed reorder buffer after the completion of a set of flush operations.

FIG. 4 is a flowchart of the local flush operation of a local reorder buffer.

FIG. 5 is a flowchart of the flush operation of a global reorder buffer.

FIG. 6 is a flowchart of the remote flush operation of a local reorder buffer.

### DETAILED DESCRIPTION

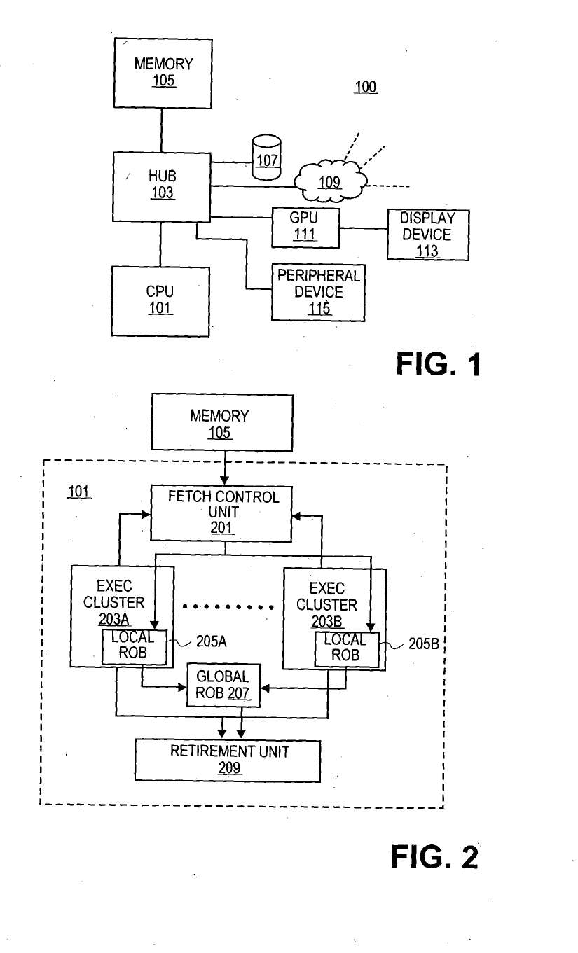

FIG. 1 is a diagram of a computer system 100. Computer system 100 includes a central processing unit (CPU) 101. CPU 101 is connected to a communications hub 103. Communications hub 103 controls communication between the components of computer system 100. In one embodiment, communications hub 103 is a single component. In another embodiment, communications hub 103 includes multiple components such as a north bridge and south bridge. Communications hub 103 handles communication between system memory 105 and CPU 101. System memory 105 stores program instructions to be executed by CPU 101. Communications hub 103 also allows CPU 101 to communicate with fixed and removable storage devices 107, network devices 109, graphics processors 111, display devices 113 and other peripheral devices 115. Computer system 100 may be a desktop computer, server, mainframe computer or similar machine.

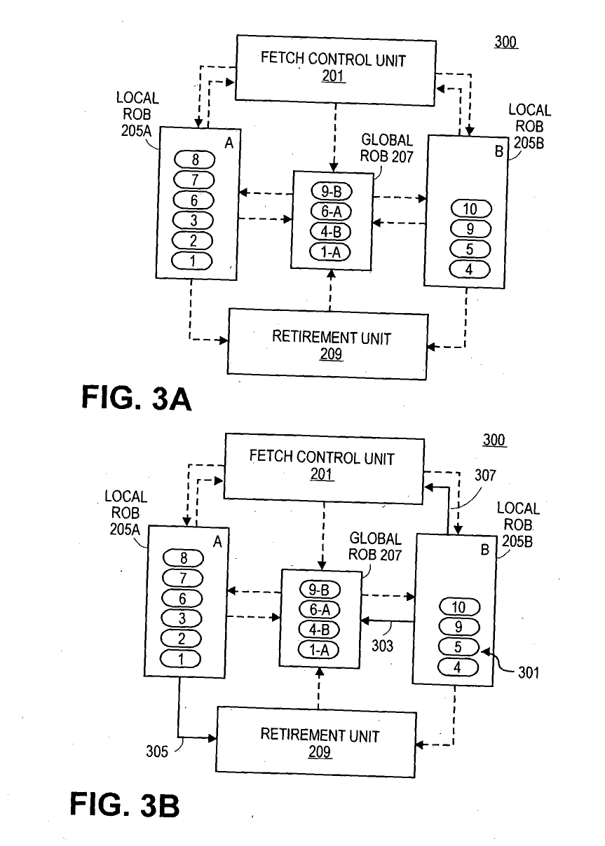

FIG. 2 is a diagram of the internal components related to parallel processing of instructions in CPU 101 and the connection with system memory 105. CPU 101 includes a set of execution clusters 203A-203B, a fetch control unit 201, global reorder buffer (global ROB) 207 and a retirement unit 209. Fetch control unit 201 manages the retrieval of instructions to be executed by execution clusters 203A-203B from system memory 105. Fetch control unit 201 may also include an apportionment unit and cache. In one embodiment, fetch control unit 201 is a single device. In another embodiment, fetch control unit 201 is a set of devices such as a cache, memory access device and apportionment device. In a further embodiment, fetch control unit 201 manages the global order of fetches to memory 105. Fetch requests may be generated from fetch units in each execution cluster 203A-203B. A cache in fetch control unit 201 may be an instruction cache, trace cache or similar cache device. The cache in fetch control unit 201 stores instructions previously or recently retrieved from memory allowing fetch control unit 201 to retrieve instructions faster than if retrieved from memory 105. Multiple caches may also be used in fetch control unit 201 to optimize performance. In one embodiment, separate caches for instructions and segments (i.e., groupings of instructions including traces) may be used. Caches for caches may be based on segments or traces that are built by repetition in the patterns of utilized instructions.

In one embodiment, the apportionment unit of fetch control unit 201 is responsible for assigning instructions retrieved from system memory 105 to available execution clusters. Instructions may be assigned to each execution cluster by a round robin scheme, a resource availability scheme or similar scheme. In one embodiment, instructions are divided into frequently used instructions and infrequently used instructions or sets of instructions. Infrequently used instructions or sets of instructions may be assigned to a first set of execution clusters and frequently used instructions or sets of instructions to a second set of execution clusters. In another embodiment, execution clusters may be optimized to perform discrete tasks such as floating point arithmetic. Fetch control unit 201 may assign instructions to execution units based on the type of computation or processing required by the instructions and the capabilities or specialization of the execution clusters.

In one embodiment, each execution cluster 203A, 203B includes a local reorder buffer (local ROB) 205A, 205B, queue or similar structure for storing the instructions to be processed by the execution cluster. CPU 101 may contain any number of execution clusters each having a local reorder buffer. In one embodiment, execution cluster 203A includes a local reorder buffer 205A and execution cluster 203B includes a local reorder buffer 205B. In one embodiment, local reorder buffer 203A stores the instructions assigned to the execution cluster 203A by fetch control unit 201. Local reorder buffers may be first-in first-out (FIFO) buffers or similar devices. Each entry in the buffer may correspond to an instruction. Each entry may also track additional data related to each instruction. In one embodiment, local reorder buffer 205A stores tags, pointers or similar data related to an instruction.

In one embodiment, local reorder buffers may also store data related to the status of the instruction or similar data related to the instructions. In one embodiment, the instructions are grouped into discrete sequences of instructions or ‘segments.’ Segments may be delineated based on control transfer instructions (CTIs) such that segments include a set of instructions that are associated with a single CTI or similar arrangement. A CTI may be a conditional branching instruction or similar event. CTIs require fetch control unit 201 to speculate as to how the CTI will be resolved and to predict subsequent instructions to be retrieved based on a ‘guess ’ as to which path will be taken after the CTI is resolved. In another embodiment, segments are delineated such that CTIs are the final instructions in the segment. Segments may be atomic blocks of instructions. Atomic blocks of instructions are sets of instructions that can be processed in parallel and if predicted by fetch control unit 201 subsequent to a CTI are discarded as a block if the prediction is inaccurate.

In one embodiment, local reorder buffers 205A, 205B are each connected with a global reorder buffer 207. Global reorder buffer 207 tracks the relative order of instructions and segments in each local reorder buffer 205A, 205B. Output or ‘retirement’ device 209 uses the global reorder buffer to determine which execution cluster contains the next instruction or segment to be output to update the architecture of CPU 101 and computer system 100. In one embodiment, retirement unit 209 is a single device that retrieves data from execution clusters 203A, 203B and updates CPU 101 architecture and generates signals to computer system 100 components. In another embodiment, retirement unit 209 is a set of components that implement the update of the architectural state. Global reorder buffer 207 also communicates with local reorder buffers 205A, 205B to update the local buffers when other execution clusters encounter mispredicted instructions. When a mispredicted instruction is encounter all instructions that were retrieved subsequent to the mispredicted instruction are erased or ‘flushed.’ A new set of instructions is then retrieved based on the actual resolution of the CTI that caused the misprediction. Global reorder buffer 207 works with local reorder buffers 205A and 205B to enforce a hierarchical distributed program reorder mechanism for CPU 101.

The hierarchical distributed system provides improved system performance by localizing the relevant sections of the reorder buffer to each execution cluster. This allows the relative program order of instructions to be primarily maintained within an execution cluster. This improves the speed of the processing of instructions because less delay is involved in updating and retrieving data from a local reorder buffer than a global reorder buffer due to the distance involved in communicating with the global reorder buffer. Overall program order is maintained by utilizing a small global reorder buffer to track the relative order of segments assigned to each local reorder buffer. Local reorder buffers and their execution clusters can operate independently because they are not dependent on the global reorder buffer to maintain coherency relative to each execution cluster. Increased instruction level parallelism (ILP) is obtained by increasing the independent operation of the execution clusters. This system is particularly effective in handling execution clusters that perform out of order (OOO) processing of instructions because the system maintains control over the retirement of instruction in program order and flushes out instructions that have been mispredicted even if processed by the execution cluster. Also, the hierarchical distributed system is not complex allowing power savings and cost effective manufacturing. Similarly, the distributed hierarchical reorder buffer improves the performance of fetch control unit 201 because local reorder buffers notify fetch control unit 201 upon detection of a mispredicted instruction allowing the faster retrieval of replacement instructions without having to wait until a global reorder buffer is notified of the misprediction of an instruction.

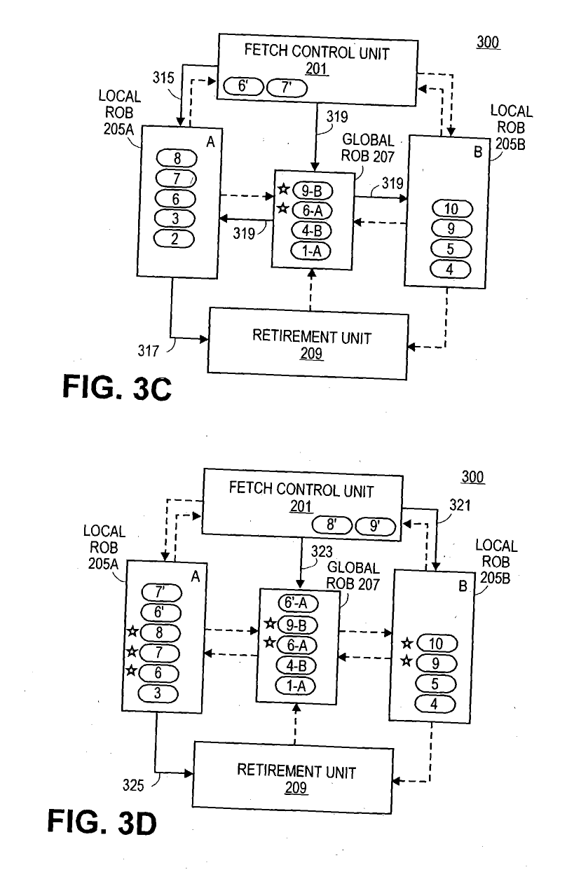

FIGS. 3A-3B illustrate an exemplary hierarchical distributed reorder buffer to demonstrate the manner in which the hierarchical distributed reorder mechanism works. The figures are a set of consecutive architectural states for the hierarchical distributed reorder buffer. Dotted lines between the devices indicate inactive communication links at a given instance of time. Solid lines between the devices indicate an active communication link.

FIG. 3A is a diagram of an exemplary hierarchical distributed reorder mechanism 300 in an initial state. In one embodiment, mechanism 300 includes fetch control unit 201, local reorder buffer A 205A, local reorder buffer B 205B, global reorder buffer 207 and retirement unit 209. Fetch control unit 201 communicates with local reorder buffers A 205A and B 205B as well as global reorder buffer 207. Fetch control unit 201 may assign instructions to the local reorder buffers and notify global reorder buffer 207 of the local buffer to which each segment is assigned. Global reorder buffer 207 is connected to local reorder buffer A 205A and B 205B to communicate misprediction notification messages from the local reorder buffers to global reorder buffer 207 and remote flush commands from global reorder buffer 207 to local reorder buffers. Local reorder buffers A 205A and B 205B are connected with retirement unit 209, which obtains processed instruction data from local reorder buffers and updates CPU 101 architecture accordingly.

In the example of FIG. 3A, local reorder buffer A 205A has been assigned a set of instructions in segments labeled according to program order. The instruction segments assigned to local reorder buffer A 205A are segments 1, 2, 3, 6, 7 and 8. Local reorder buffer B 205B has been assigned segments 4, 5, 9 and 10. In one embodiment, global reorder buffer 207 tracks the ‘switch points.’ A switch point is the first segment in a sequence of consecutive segments that have been assigned to a single execution cluster or local reorder buffer. Global reorder buffer 207 also tracks which local reorder buffer is associated with each switch point. In the example, global reorder buffer 207 includes a first switch point for segment 1 that indicates that segment 1 and subsequent segments until the next switch point are contained in local reorder buffer A 205A. Global reorder buffer 207 also contains switch points for segment 4 in local reorder buffer B 205B, segment 6 in local reorder buffer A 205A, and segment 9 in local reorder buffer B 205B.

FIG. 3B illustrates the next stage in the example. In this stage of the example, mispredicted instruction is detected in segment 5 301 by execution cluster 203B. The misprediction of an instruction is detected when the condition upon which a CTI is dependent is actually resolved. In the case where the actual resolution of the condition does not match the guess of the fetch control unit 201 a misprediction of subsequent instructions and segments has occurred. In this example, the CTI that generated the mispredicted instruction is at the end of segment 5. Thus, subsequent segments are also assumed to be mispredicted. However, there are no consecutive segments after segment 5. In another scenario, the CTI may occur before the end of a segment (e.g., segment 5). The entire segment is then marked to be flushed including instructions that precede the mispredicted instruction in segment 5. Segments may be processed out of order (OOO). A mispredict may be detected in any segment in a local reorder buffer. As a result, segments that may already have been processed may be flushed because they have not been output from the local reorder buffer at the time that a mispredicted instruction is detected in a segment that precedes the processed segment.

In one embodiment, local reorder buffer B 205B notifies via signal 303 global reorder buffer 207 of the misprediction. The notification includes information identifying the segment that contained the misprediction and may include data identifying the local reorder buffer that generated the notification. In another embodiment, the identity of the local reorder buffer is determined based on the signal line that the notification was received on.

In one embodiment, local reorder buffer B 205B notifies fetch control unit 201 of a mispredicted instruction via signal 307. The notification includes data identifying the instruction that had been mispredicted or the segment of the CTI that caused the misprediction. Fetch control unit 201 may utilize this data to fetch the correct instructions subsequent to the mispredicted CTI. In one embodiment, during the same time period that the misprediction of an instruction is detected in local reorder buffer B 205B retirement unit 209 retrieves the next segment of instructions to be implemented in CPU 101 architecture or to generate signals to computer system 100 components. In one embodiment, retirement unit 209 relies on data stored in the local reorders buffers that tracks switch points in the assignment of segments to local reorder buffers. Retirement unit 209 uses this data to properly determine the order and location of instructions to be retired. In another embodiment, retirement unit 209 receives switch point data from the global reorder buffer 207. In the example, segment 1 is retired via signal 305. A retired local reorder buffer entry is then removed (i.e., deleted) from the local reorder buffer.

FIG. 3C is a diagram of the next stage of the exemplary operation of the hierarchical distributed reorder mechanism 300. At this stage, global reorder buffer 207 issues a set of remote flushing commands via signals 319. In one embodiment, after global reorder buffer 207 receives a notification of a local reorder buffer flush, global reorder buffer 207 compares the data identifying the local reorder buffer and the segment that caused the mispredicted instruction with the switch data stored by global reorder buffer 207. Global reorder buffer 207 determines which switches and segments are associated with instructions that occur after the mispredicted instructions. Global reorder buffer 207 sends notifications or remote flush commands via signals 319 to each local reorder buffer that contains segments or instructions that occur in program order subsequent to the mispredicted CTI. In one embodiment, once all remote flush commands have been distributed to local reorder buffers, the local reorder buffers may accept new segments and replacement segments independent of the flushing operation undertaken in any other local reorder buffer or in the global reorder buffer. In another embodiment, the assignment of new or replacement segments is adjusted to consider the amount of activity in each cluster associated with each local reorder buffer. The assignment of segments considers other cluster activity including the processing of flushing operations. This scheme of segment allotment balances the processing load of each cluster. Global reorder buffer 207 also marks switch entries for deletion that are associated with segments to be flushed (indicated by a star in the diagram).

In one embodiment, at approximately the same time (e.g., during the same cycle), in this example, fetch control unit 201 operates independently to retrieve replacement segments labeled 6′ and 7′. Fetch control unit 201 assigns these segments via signal 315 to local reorder buffer A 205A. Fetch control unit 201 also notifies global reorder buffer 207 of the assignment of segments 6′ and 7′ to local reorder buffer A 205A via signal 319. In one embodiment, the retrieval and assignment of segments to local reorder buffers is orthogonal to the flushing processes carried out by the local reorder buffers and global reorder buffer 207. Also, occurring independently, retirement unit 209 retrieves via signal 317 the next segment, segment 2, to implement in architecture of CPU 101 or to generate signals to components of computer system 100. Segment 1 has been deleted from local reorder buffer A 205A because it had been processed by retirement unit 209.

FIG. 3D illustrates the next stage of the exemplary operation of the hierarchical distributed reorder mechanism 300. In this stage, local reorder buffer A 205A marks segments 6, 7 and 8 for flushing in response to receiving the remote flush command from global reorder buffer 207. Local reorder buffer A 205A compares the sequence information or segment identification of the CTI that generated the mispredicted instruction to the local reorder buffer A 205A entries to determine each segment in the local reorder buffer that is in program order subsequent to that CTI. Each segment that is subsequent in program order to the CTI that generated the misprediction is marked for flushing. Similarly, local buffer B 205B also marks for flushing all segments subsequent to the CTI. In this example, segments 6, 7, and 8 in local buffer A 205A and segments 9 and 10 in local buffer B 205B are marked for flushing.

In one embodiment, independent of the processing of the remote flush operation by each local reorder buffer, fetch control unit 201 fetches further instructions and assigns these instructions to the local reorder buffers. In this example, segments 6′ and 7′ are loaded into local reorder buffer A 205A. Fetch control unit 201 also retrieves segments 8′ and 9′. These segments are assigned via signal 321 to local reorder buffer B 205B. Fetch control unit 201 also notifies via signal 323 global reorder buffer 207 of the assignment of segments 8′ and 9′ to local reorder buffer B 205B. Global reorder buffer 207 adds an entry indicating a switch point at segment 6′ has been added to local reorder buffer A 205A. Retirement unit 209 processes the next segment via signal 325, which is segment 3.

FIG. 3E is a block diagram of the next stage of the exemplary hierarchical distributed reorder mechanism 300. The flush operations in local reorder buffer A 205A, local reorder buffer B 205B and global reorder buffer 207 complete by deleting marked segments. Fetch control unit 201 completes the load of segments 8′ and 9′ into local reorder buffer B 205B. Retirement unit 209 retrieves the next segment to be retired via signal 331. In the example, the next segment to be retired is segment 4 in local reorder buffer B 205B. Global reorder buffer 207 deletes switch data upon notification from the retirement unit 209 via signal 333 that the next set of segments is being retired. In another embodiment, global reorder buffer 207 is notified by each local reorder buffer when a segment associated with a switch point is prepared for retirement. In this example, the switch point for segment 1 is deleted when segment 4, the starting segment of the next switch point, is retired.

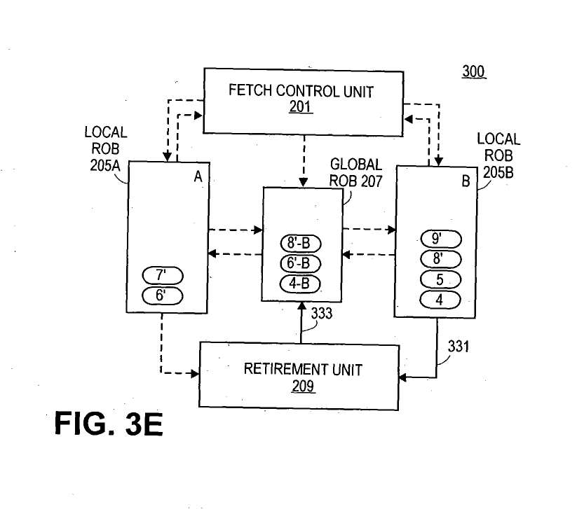

FIG. 4 is a flowchart of the local flush operation of a local reorder buffer 205A, 205B. In one embodiment, the local flush operation is initiated when the execution cluster associated with the local buffer resolves a CTI (block 401). If the CTI had been correctly predicted then local reorder buffer continues to wait until the next CTI is resolved. In one embodiment, the local reorder buffer does not actively monitor, the resolution of CTIs. Instead the local reorder buffer initiates a flush operation when the associated execution unit notifies the local reorder buffer of a CTI misprediction. If the CTI resolution is not what was predicted by fetch control unit 201 and loaded into the local reorder buffer then a misprediction has occurred (block 403).

In one embodiment, the local reorder buffer determines the location of the CTI that was mispredicted (block 405). If the CTI was at the end of a segment then only subsequent segments are affected by the misprediction. The local reorder buffer marks for flushing each segment subsequent to the segment with the CTI that generated the misprediction up to the next switchpoint. In one embodiment, the local reorder buffers track switch points along with other data regarding the segments. The local reorder buffer then notifies the global reorder buffer of the segment where the CTI is located that generated the misprediction (block 409). If the CTI is not at the end of a segment then the local reorder buffer also marks the entire segment where the CTI was located for flushing including instructions that may already have been processed by the associated execution cluster in addition to the subsequent segments until the next switch point (block 407). The local reorder buffer then notifies the global reorder buffer of the segment in which the misprediction occurred (block 409). The flush of marked segments is then initiated and completes when each has been deleted.

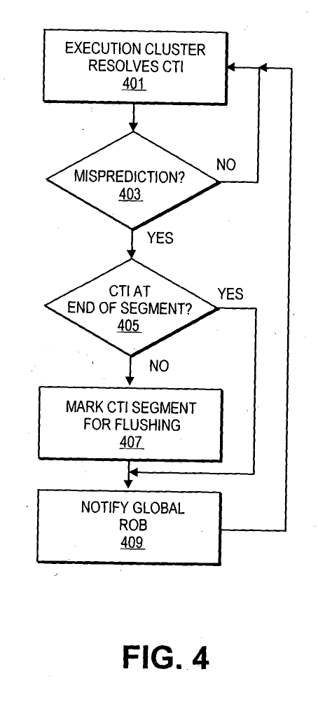

FIG. 5 is a flowchart of a flush operation of global reorder buffer 207. In one embodiment, global reorder buffer 207 initiates a flush operation upon receipt of a misprediction notice from a local reorder buffer (block 501). Global reorder buffer 207 determines which switches stored in global reorder buffer 207 are subsequent to the segment that generated the misprediction (block 503). Global reorder buffer 207 sends a remote flush command to each local reorder buffer that has a segment entry that is indicated by a subsequent switch entry or a segment entry that is subsequent to the segment indicated by the subsequent switch entry (block 505). Each switch entry that tracks a segment subsequent to the misprediction segment is marked to be flushed (block 507). A flush operation is then initiated to delete each entry marked for flushing from global reorder buffer 207.

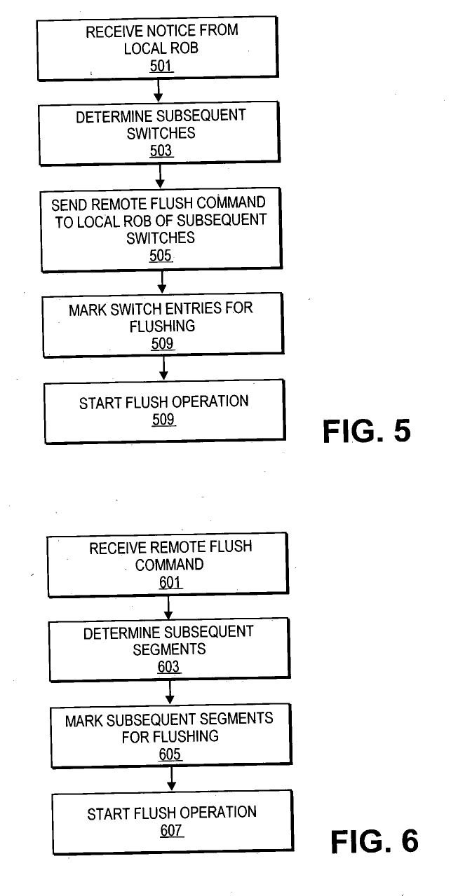

FIG. 6 is a flowchart of a remote flush operation for a local reorder buffer. In one embodiment, a remote flush operation is initiated by a local reorder buffer upon receipt of a remote flush command from global reorder buffer 207 (block 601). The local reorder buffer determines each segment stored in the reorder buffer that is subsequent in program order to the segment identified in the remote flush command (block 603). Each segment in the reorder buffer that is subsequent to the segment that generated a misprediction is marked to be flushed (block 605). A flush operation is then initiated to delete the marked segments (block 607).

The hierarchical distributed reorder buffer system has improved efficiency in power savings, improved parallelism and speed due to the distributed architecture and localization or reorder tracking data. Tracking of the program instruction order is primarily performed local to each execution cluster reducing the amount of signaling and power consumed in communicating with the global reorder buffer. Parallelism is improved by the increased independence of the execution clusters in the distribute system. This increased independence improves the throughput of data in the CPU 101 and improves the overall computer system 100 speed.

In another embodiment, the hierarchical distributed reorder buffer system is used in a network device such as a router or similar device to maintain packet order or network data order. Packets, subcomponents of packets, frames and similar networking protocol groupings of data may be tracked by the hierarchical distributed reorder buffer. Networking protocols and packet handling often requires the out of order handling of packets or similar data. However, after processing, this data typically needs to be retransmitted in original order. Global reorder buffers are typically used for maintaining the order of network data. The hierarchical distributed reorder buffer is configured to track the order of packets or network data allowing efficient reordering with improved performance.

In one embodiment, the hierarchical distributed reorder buffer is implemented in software (e.g., microcode or higher level computer languages). The software implementation may also be used to run simulations or emulations of the hierarchical distributed reorder buffer. A software implementation may be stored on a machine readable medium. A “machine readable” medium may include any medium that can store or transfer information. Examples of a machine readable medium include a ROM, a floppy diskette, a CD-ROM, an optical disk, a hard disk, a radio frequency (RF) link, or similar media.

In the foregoing specification, the invention has been described with reference to specific embodiments thereof. It will, however, be evident that various modifications and changes can be made thereto without departing from the broader spirit and scope of the invention as set forth in the appended claims. The specification and drawings are, accordingly, to be regarded in an illustrative rather than a restrictive sense.

1. A device comprising:
a first device to track sequential data order associated with a first execution unit;
a second device to track sequential data order associated with a second execution unit; and
a third device coupled to the first device and second device to track sequential data order of data stored in the first device and the second device.

2. The device of claim 1, wherein the first device is operable to notify the third device of mispredicted sequential data, and
wherein the first device is operable to flush a first set of sequential data.

3. The device of claim 2, wherein the third device to notify the second device of mispredicted sequential data, and
wherein the second device is operable to flush a second set of sequential data.

4. The device of claim 2, wherein the third device is operable to notify the first device of mispredicted sequential data, and
wherein the first device is operable to flush a third set of sequential data.

5. The device of claim 1, further comprising:
a fetch control unit to predict sequential data, fetch the sequential data and assign the sequential data to one of the first device and the second device during a flush operation.

6. A method comprising:
tracking the program order of a first set of instructions assigned to a first local reorder buffer in a first execution unit;
tracking the program order of a second set of instructions assigned to a second local reorder buffer in a second execution; and
tracking program order of the first set of instructions relative to the second set of instructions in a global reorder buffer.

7. The method of claim 6, further comprising:
notifying the global reorder buffer when a mispredicted instruction occurs;
intiating a flush operation in the global reorder buffer; and
notifying the first local reorder buffer of the mispredicted instruction.

8. The method of claim 7, further comprising:
notifying a fetch control unit of a mispredicted set of instructions.

9. The method of claim 6, further comprising:
sending a signal to the second local reorder buffer to flush at least a third set of instructions.

10. The method of claim 6, further comprising:
fetching a fourth set of instructions; and
assigning the fourth set of instruction to the first reorder buffer during a flushing operation.

11. The method of claim 6, further comprising:
retiring an instruction according to an indicator stored in the global reorder buffer.

12. A system comprising:
a bus;
a memory device coupled to the bus; and
a processor including a fetch control unit to fetch instructions from the memory device, a first execution unit to process one or more of the fetched instructions, a second execution unit to process one of more of the fetched instructions, a first reorder buffer to track instructions assigned to the first execution unit, a second reorder buffer to track instructions assigned to the second execution unit, and a global reorder buffer to track instruction order of instructions assigned to the first reorder buffer relative to the second reorder buffer.

13. The system of claim 12, wherein the first reorder buffer is operable to signal the global reorder buffer upon detection of a mispredicted instruction.

14. The system of claim 12, wherein the first reorder buffer is operable to flush a first set of instructions upon detection of a mispredicted instruction, and
wherein the fetch control unit assigns a second set of instructions to the first reorder buffer based on a set of load balancing criteria.

15. A machine readable medium having stored therein instructions, which when executed cause a machine to perform a set of operations comprising:
tracking the program order of a first set of instructions assigned to a first local tracking device in a first execution unit;
tracking the program order of a second set of instructions assigned to a second local tracking device in a second execution unit; and
tracking program order of the first set of instructions relative to the second set of instructions in a global tracking device.

16. The machine readable medium of claim 15, having further instructions stored therein which when executed cause a machine to perform a set of operations further comprising:
notifying the global tracking device when a mispredicted instruction occurs.

17. The machine readable medium of claim 16, having further instructions stored therein which when executed cause a machine to perform a set of operations further comprising:
tracking a first set of switch points in the global tracking device.

18. The machine readable medium of claim 16, having further instructions stored therein which when executed cause a machine to perform a set of operations further comprising:
flushing a second set of switch points based on the mispredicted instruction.

19. A apparatus comprising:
a means for tracking the program order of a first set of instructions assigned to a first local tracking device in a first execution unit;
a means for tracking the program order of a second set of instructions assigned to a second local tracking device in a second execution unit; and
a means for tracking program order of the first set of instructions relative to the second set of instructions in a global tracking device.

20. The apparatus of claim 19, further comprising:
a means for notifying the global tracking device when a mispredicted instruction occurs.

21. The apparatus of claim 19, further comprising:
a means for flushing at least a third set of instructions in the first local tracking device.
